(19) United States
(12) Patent Application Publication
(10) Pub. No.: US 2013/0063598 A1
(43) Pub. Date: Mar. 14, 2013

(54) REARVIEW MIRROR

(71) Applicants: Chia-Sheng HSIAO, New Taipei City (TW); Wen-Rong WU, New Taipei City (TW); Yu-Chen CHANG, New Taipei City (TW); Ming-Hung WANG, New Taipei City (TW)

(72) Inventors: Chia-Sheng HSIAO, New Taipei City (TW); Wen-Rong WU, New Taipei City (TW); Yu-Chen CHANG, New Taipei City (TW); Ming-Hung WANG, New Taipei City (TW)

(73) Assignee: SYSGRATION LTD., New Taipei City (TW)

(21) Appl. No.: 13/607,606

(22) Filed: Sep. 7, 2012

(30) Foreign Application Priority Data
Sep. 13, 2011 (TW) 100217068

(51) Int. Cl. H04N 7/18

(52) U.S. Cl. 348/148; 348/E07.085

(57) ABSTRACT

A rearview mirror is provided with dashboard camera functions and includes a mirror surface of the rearview mirror, an image processing unit coupled with an underneath of the rearview minor and linking the image capture unit, a display unit installed on the mirror surface to display images retrieved by the image capture unit, an input unit mounted on the rearview mirror body for operating commands entered by one user, and a control processing module which is installed inside the rearview mirror body, links the image capture unit and the display unit, and receives instructions from the input unit to control operations of both the image capture unit and the display unit.

### CROSS REFERENCE TO RELATED APPLICATIONS

This application claims priority of Application No. 100217068 filed in Taiwan, R.O.C. on Sep. 13, 2011 under 35 U. S.C. §119, the entire contents of all of which are hereby incorporated by reference.

### BACKGROUND OF THE INVENTION

1. Field of the Invention

The present invention relates to a rearview mirror and, in particular, a rearview mirror having dashboard camera functions which can display images recorded by a moving car on the rearview mirror's screen and save recorded images in a memory card.

2. Description of the Prior Art

To drive safely, a car driver has to focus on the road ahead and is informed of traffic status behind their vehicle by a rearview mirror. However, other audio or video signals induced by car-borne devices distract a driver from the status of the road and have a detrimental effect on driving safety. If a driver's line of vision deviates from the front during operation of any car-borne device, safety of the drive may be jeopardized. Therefore, effectively improving driving safety is an issue waiting to be solved by persons with ordinary skills in the art.

### SUMMARY OF THE INVENTION

An object of the present invention is to provide a rearview mirror which coordinates a dashboard camera to eliminate a camera's blind spot and realize the best monitoring effect.

The present invention provides a rearview mirror with dashboard camera functions, comprising, a rearview mirror body with a mirror surface, an image capture unit which is installed below and rotated against the rearview mirror body and provided with (a) a retainer part protruding from the rearview mirror body to limit a turning angle of the image capture unit relative to the rearview mirror (max. degree: 180 degrees), (b) Charge Coupled Devices (CCD) or Complementary Metal Oxide semiconductors (CMOS), and (c) at least an infrared LED, a display unit such as a Liquid Crystal Display or a Light Emitting Diode screen installed on a mirror surface to display images which have been received by the image capture unit, an input unit exposed to the rearview mirror body for operating commands entered by one user and a control processing module installed in the rearview mirror body and electrically connected to both the image capture unit and the display unit, which retrieves signals from the input unit.

The rearview mirror of the present invention further comprises a memory card slot used to record images retrieved by the image capture unit, wherein the memory card slot's male connector is available to a Secured Digital Card, a Compact Flash Card, a Multi Media Card, a Smart Media Card, an xD-Picture Card and a Memory Stick, and a USB port used to link a cable and access images in a memory card which is connected to a notebook computer or a tablet personal computer.

To realize the above, the rearview mirror of the present invention is placed at one position with the best field of vision for a dashboard camera, so as to improve problems with driving safety caused by a camera's blind spots or obstruction of a driver's line of vision.

These features and advantages of the present invention will be fully understood and appreciated from the following, detailed description of the accompanying drawings.

### BRIEF DESCRIPTION OF THE DRAWINGS

FIG. 1 is a block diagram for the rearview mirror of the present invention;

FIG. 2 is a perspective view for the review mirror of the present invention;

FIG. 3 is a front view for the review mirror of the present invention;

FIG. 4 is a perspective view for the review mirror of the present invention, with an image capture unit turned to a specific angle;

FIG. 5 is a side s for the review mirror of the present invention; and

FIG. 6 is a rear view for the review mirror of the present invention.

### DESCRIPTION OF REFERENCE CHARACTERS OF IMPORTANT PARTS

100 Control Processing Module

101 Power Supply

102 Function Key

103 Input Unit

104 Display Unit

105 Image Capture Unit

200 Rearview Mirror

201 Indicator

202 Infrared LED

203 Memory Card Slot

204 USB Port

205 Mirror Surface

206 Image Display Apparatus

207 Motor

### Detailed Description of the Preferred Embodiment

FIG. 2 is a perspective view of the rearview mirror featuring dashboard camera functions of the present invention, comprising a mirror surface 205, a control processing module 100, a display unit 104, an input unit 103, and an image capture unit 105.

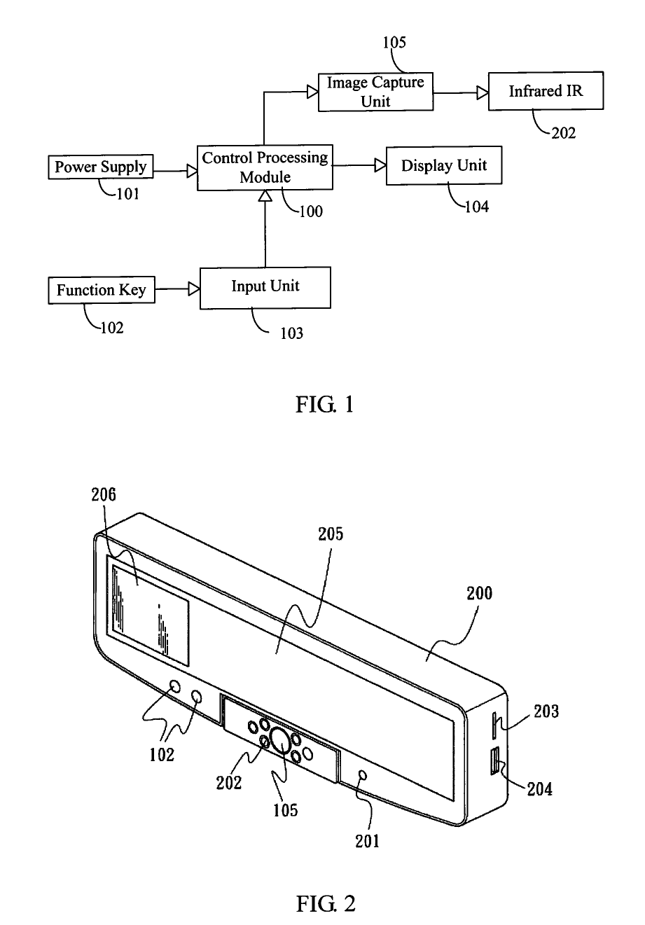

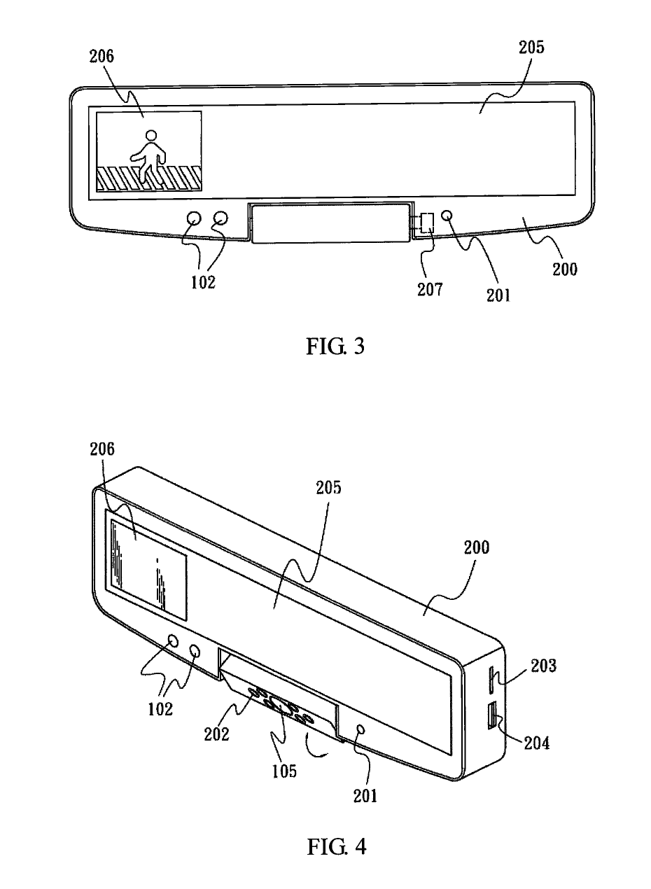

FIG. 1 illustrates the control diagram of a rearview mirror for the present invention, and FIG. 3 illustrates a front view of the rearview mirror for the present invention as shown in FIG. 2. As shown in these figures, the rearview mirror is provided with a dashboard camera control processing module 100 and a rearview mirror 200. The control processing module 100 comprises a power supply 101, a function key 102, an input unit 103, a display unit 104, an image capture unit 105 and an Infrared LED (IR LED) 202. The rearview mirror 200 comprises an indicator 201, an IR LED 202, a memory card slot 203, a USB port 204, a mirror surface 205, an image display apparatus 206, a motor 207, a function key 102, and an image capture unit 105.

As shown in FIG. 1, the power supply 101 in the control processing module 100 provides electricity necessary for activating the control processing module 100. The function key 102 is set to zoom in or zoom out images captured by the dashboard camera. The image capture unit 105 has an lens composed of Charge Coupled Devices (CCD) or Complementary Metal Oxide Semiconductors (CMOS).

As shown in FIG. 2, the IR LED 202 is activated to shoot and record images simultaneously and the display unit 104 is turned on. In the case of interior images being captured by the image capture unit 105, the images will be automatically upside-down to display and record interior status according to camera angles adjusted by one user. The IR LED 202 is a light sensor which is capable of sensing a light source of the image capture unit 105.

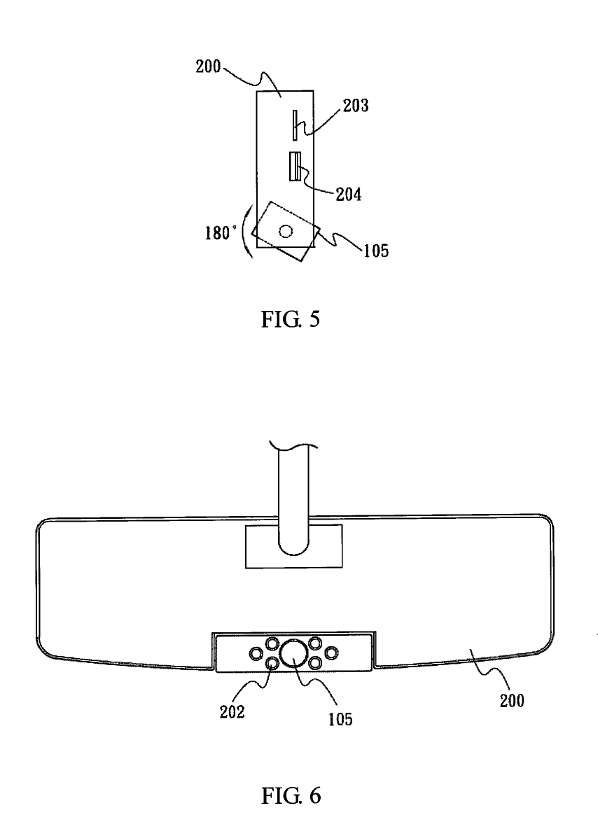

Referring to FIG. 4 and FIG. 6, FIG. 4 is a perspective view for the rearview mirror of the present invention with the image capture unit turned to an angle. FIG. 5 is a side view of the rearview mirror for the present invention as shown in FIG. 3. In FIG. 5, the image capture unit 105 can be set to be rotatable by means of the rearview mirror's function key 102 and electrically turned to a user's required angle (max. angle: 180 degrees) by the motor 207. Furthermore, the function key 102 is used to set an extra function for another window selectively activated by and displayed to a driver or user.

FIG. 5 is a side view of the rearview mirror for the present invention as shown in FIG. 4. The rearview minor 200 is provided with an indicator which expresses the image capture unit 105 in operation. The image display 206 is effective in displaying images shot by the image capture unit 105 via the display unit 104 and is either a Liquid Crystal Display (LCD) or a Light Emitting Diode (LED) screen. The memory card slot 203 is designed for one memory card such as xD-Picture Card (XD Card), Secured Digital Card (SD), Compact Flash Card (CF), Multi Media Card (MMC), Smart Media Card (SMC) or Memory Stick (MS), which is convenient for saving shot images and which is easily taken out by it driver or user. The USB port 204 is designed to directly link a notebook computer or a tablet personal computer to access recorded images via a cable. The mirror surface 205 is installed to offer a user or driver an opportunity to overtake another vehicle or observe status behind while making a turn. The motor 207 is effective in providing power required by the rotatable image capture unit 105.

Many changes and modifications in the above described embodiment of the invention can, of course, be carried out, without departing from the scope thereof. Accordingly, to promote the progress in science and the useful arts, the invention is disclosed and is intended to be limited only by the scope of the appended claims.

What is claimed is:

1. A rearview mirror with dashboard camera functions, comprising:
a rearview mirror body with a mirror surface;
an image capture unit which is coupled with an underside of the rearview mirror body and rotated against the corresponding rearview mirror body;
a display unit installed on the mirror surface to display images retrieved by the image capture unit;
an input unit exposed to the rearview mirror body for any operating command entered by one user; and
a control processing module installed inside the rearview mirror body and electrically connected to both the image capture unit and the display unit, linking the input unit to control the image capture unit and the display unit.

2. The rearview mirror according to claim 1, further comprising a memory card slot.

3. The rearview mirror according to claim 1, further comprising a USB port.

4. The rearview mirror according to claim 1 wherein the display unit is either a Liquid Crystal Display or a Light Emitting Diode screen.

5. The rearview mirror according to claim 1, wherein the image capture unit is composed of Charge Coupled Devices (CCD) or Complementary Metal Oxide Semiconductors (CMOS).

6. The rearview mirror according to claim 1, wherein the image capture unit is provided with at least an infrared LED.

7. The rearview mirror according to claim 1, further comprising a retainer part protruding from the rearview mirror body and installed near the image capture unit to limit an angle of the image capture unit rotated against the corresponding rearview mirror.

8. The rearview mirror according to claim 2, wherein the memory card slot is a male connector available to one device such as a Secured Digital Card, Compact Flash Card, Multi Media Card, and xD-Picture Card and Memory Stick.

9. The rearview mirror according to claim 7 wherein the image capture unit can be turned within a range from 0 to 180 degrees.

10. The rearview mirror according to claim 1, further comprising an indicator expressing the image capture unit in operation.
